(19) United States
(12) Patent Application Publication
(10) Pub. No.: US 2015/0052033 A1
(43) Pub. Date: Feb. 19, 2015

(54) METHOD, SYSTEM, SERVICE, AND COMPUTER PROGRAM PRODUCT FOR VERIFICATION AND DELIVERY OF INCOME TAX RETURN INFORMATION

(71) Applicant: PointServ, Inc., Burlingame, CA (US)

(72) Inventors: Iavor BOYANOV, Burlingame, CA (US); Iordan GAVAZOV, San Carlos, CA (US)

(73) Assignee: PointServ, Inc., Burlingame, CA (US)

(21) Appl. No.: 14/103,455

(22) Filed: Dec. 11, 2013

Related U.S. Application Data
(60) Provisional application No. 61/865,446, filed on Aug. 13, 2013.

(51) Int. Cl. G06Q 40/00

(52) U.S. Cl. CPC G06Q 40/123
USPC 705/31

(57) ABSTRACT

A technique of income verification for making a lending decision is disclosed that does not require requesting tax transcripts from the Internal Revenue Service and performing a manual comparison of the tax transcripts to tax returns provided by the borrower. The borrower provides authentication information (e.g., login credentials), which a verification service utilizes to obtain the borrower's tax information from an E-file tax preparation provider. An optional checking process can be used to check that the tax return has not been amended. The verification service delivers verified income data and tax returns to the lender, which can be provided securely in a tamper proof form. Techniques to provide privacy protection for the borrower may include a privacy protection protocol. Additionally, a certificate of authenticity may be provided to the lender.

### CROSS-REFERENCE TO RELATED APPLICATIONS

This application claims the benefit of priority under U.S.C. §119(e) to U.S. Provisional Patent Application No. 61/865,446, filed on Aug. 13, 2013, which is incorporated herein by reference in its entirety for all purposes.

### BACKGROUND OF THE INVENTION

1. The Field of the Invention

The invention relates to a process for confirming the authenticity of an income tax return (“Tax Return”) by obtaining the tax return, and information about it, from trustable sources such as the IRS, state departments and agencies that collect income taxes, and E-File software providers (“E-File Providers”). E-File providers are companies that offer computer programs that a taxpayer can use to prepare and file their tax returns electronically. Many of these providers offer their software as a service through a website accessible over the Internet.

2. Existing Process Used Throughout the U.S. Mortgage Industry to Verify Tax Information

In applying for a loan (e.g., home mortgage), a borrower is required to fill out various forms for the lender, and also provide evidence of the borrower's ability to pay back the loan. This includes providing proof of the borrower's income and assets. One form of information that is normally required of the borrower is a copy of the borrower's income tax returns in order to perform a check of the borrower's income.

However, income tax records provided by a borrower could be incorrect or falsified. To provide a safeguard against potential mortgage fraud, it is an industry-wide practice to also verify the income tax return. For example, companies such as CreditPlus, Inc. of Salisbury Md., offer tax verification reports, typically within about 48 hours. This time delay is associated with both the time required for the verification service to obtain transcript information from the Internal Revenue Service and any additional time required by the verification service to perform additional manual checking.

This verification process follows a de facto industry standard in that it is the practice of major government backed lending programs (Fannie Mae and Freddie Mac programs), and also major banks and other lending institutions. In particular, in the prior art, the borrower is required to execute a 4506-T form (a standard government form requesting a copy of a tax form), and then the transcript of the borrower's tax return is ordered from the Internal Revenue Service. An additional manual verification step is then performed by a third party vendor. However, this industry standard process is very inefficient.

FIG. 1 sets forth the prior art process. Currently, any person or an institution interested in obtaining a verified copy of an income tax return (“Interested Party”) of another taxpayer must follow a tedious and time consuming process to do so (FIG. 1). The prior art process includes multiple steps that must be performed by a borrower 105, a lender 110, a third party vendor 115, and the Internal Revenue Service 120. We now discuss the major steps from the standpoint of an interested party (typically the lender or someone associated with the lending process).

First, the interested party must obtain a copy of the tax return from the taxpayer. That step in itself could be difficult and time consuming in some instances as the taxpayer must first locate a copy of the tax return, and then submit it to the interested party.

As a second step, the interested party must obtain consent from the taxpayer that authorizes the appropriate government agency to release data about the tax return to the interested party. For example, to get a transcript of a federal income tax return the taxpayer would need to sign IRS form 4506-T (“Request for Transcript of Tax Return”).

The next step in the process would be for the interested party to contact and request the necessary data from the appropriate government agency. This can be done directly, but in most cases, it is done through a third party vendor company that specializes in processing such requests. This step may take many days to complete, for example, in the case of obtaining transcripts of federal income tax returns, the fastest way to do so is to use the IRS' “Income Verification Express Service (IVES),” and typical, turnaround time is two business days. Additionally, the IRS has strict cutoff times, which can mean that if a prospective borrower begins the paperwork before a holiday weekend, the transcripts may not arrive for many days. For example, in 2013, the IRS states on its website that transcript requests received after 2:00 p.m. the business day prior to a holiday will be considered received on the day following the holiday. For example, if the holiday is on a Monday and the transcript is received after 2:00 p.m. on the Friday before the holiday, then in adherence with the 2-day turnaround timeframe, the request is considered received by the IRS on Tuesday morning and will be processed by Thursday morning following the holiday.

Finally, once data is returned back from the appropriate agency, the interested party must spend time and resources to reconcile that data to the tax return provided by the taxpayer in order to ensure its authenticity. This manual step can also be performed, in some cases, by a third party vendor.

Now consider the steps from the standpoint of a legitimate borrower. The legitimate borrow has to find their tax returns and provide a copy to the interested party. This itself can be a burden if the user is providing a hardcopy, as the user must find and copy the tax return. If a softcopy is provided by email, the borrower's confidential information might be compromised. Additionally, the borrower must execute and sign the IRS form 4506-T and return either a hardcopy or a softcopy of the signed form. Additionally, the legitimate borrower may be in a hurry to go house hunting. The fact that the traditional process takes several days to complete can be frustrating to a legitimate borrower with a tight schedule.

Thus, the existing process is very tedious and time consuming as it requires manual actions from each party involved—the borrower must look for a copy of the tax return, and must find a way to submit it to the interested party, the interested party or its third party representative must obtain and validate the taxpayer's consent form, the government tax authority must validate and process the request for tax return data, and finally the interested party must reconcile the tax return data against the tax return provided by the taxpayer.

Therefore, the present invention was developed to address the drawbacks of the prior art approach.

### SUMMARY OF THE INVENTION

Having a borrower provide tax returns to verify their income to a mortgage lender suffers from the problem that a borrower might deliberately submit fake, incorrect, or falsified tax returns. Thus, most lenders do not rely solely on tax returns submitted by a borrower. Additional anti-fraud measures are required to reduce the risk of mortgage fraud.

The de facto standard in the mortgage loan industry used to verify income of borrowers is inefficient and typically requires several days to complete and requires steps such as ordering tax transcripts from the Internal Revenue Service and performing a manual comparison between the tax transcripts and copies of tax returns provided by a borrower. Additionally, in the prior art a legitimate borrower has the burden of providing copies of their tax returns, signing and returning the IRS authorization form, and weighting days for the process to complete. Additionally, there is a potential privacy concerns for a legitimate borrower.

To overcome these limitations, it is therefore an object of the present invention to provide a fast, convenient process to obtain a verified copy of income tax return information, which may include a verified copy of a tax return and/or a verified summary of relevant tax return information, such as an income verification. In accordance with the invention, needless steps from the existing process used in the mortgage loan industry are eliminated and the time required for verifying income tax information is significantly reduced.

The present invention provides a paradigm shift in the mortgage industry for verifying income. The inventors have recognized that the majority of borrowers file their tax returns via an e-file tax preparation service. The records of the e-file provider can be accessed by a trusted verification service and additional layers of checking, security, and tamper proofing can be provided in order to deliver verified tax information to a lender. To achieve the objects of the invention, in one embodiment, there is provided a method for a trusted verification service to access a borrower's tax return information from an e-file tax preparation provider. One or more checks can be optionally performed by the verification service to confirm that the returns were accepted by the Internal Revenue Service and that the borrower did not amend their taxes after an initial filing. The end product is a verified tax return, meaning a copy of a tax return that is verified to be authentic by the nature of the sources from where it was obtained—i.e., it is based on information submitted to the Internal Revenue Service and thus protects against common forms of fraud seen in the mortgage industry in which a borrower submits falsified tax returns. Additional security protection can be included, such as providing the tax return information in a tamper-proof file and using secure communications between the verification service and lender.

Moreover, the present invention provides convenience and privacy protection to legitimate borrowers. The legitimate borrower does not have to submit tax records in addition to filing out and submitting a 4506-T form. The borrower saves time in the loan process. Additionally the legitimate borrower does not have to submit tax records via insecure email connections. Features are preferably included to provide a high level of privacy and security for the borrower's confidential information.

An exemplary method comprises the steps of a trusted verification service receiving the taxpayer's data and consent, obtaining a tax return directly from an E-File provider over the Internet, and confirming with the appropriate government tax authority that the tax return has not been amended. The process may be triggered by a request from a lender, resulting in the borrower being provided with a link or a user interface to enter the data and consent. The borrower is not involved in accessing the tax return such that the borrower is prevented from tampering with and falsifying the tax return. Additional privacy and security protection may be provided by securely providing the tax information to the lender in a tamper-proof file. A certificate of authenticity may also be generated for the lender.

An exemplary system for implementing the method is a computer based system having one or more servers and interfaces. The system may be implemented as a third party service aiding lenders. However, more generally the system may also be implemented by other parties, such as by an e-file tax preparation service or by a lender.

### BRIEF DESCRIPTION OF THE DRAWINGS

FIG. 1 provides an example of how the de facto industry standard process works when verifying the authenticity of a federal income tax return for a mortgage lender in accordance with the prior art.

FIG. 2A illustrates a method for providing income verification in accordance with an embodiment of the present invention.

FIG. 2B illustrates a method for verifying the authenticity of a federal income tax return in accordance with an embodiment of the present invention.

FIG. 3 compares the process examples outlined in FIG. 1 and FIG. 2B.

FIG. 4 is a system view of the process that takes place when utilizing the present invention, outlining the software modules that are involved in a typical use example in accordance with an embodiment of the present invention.

FIG. 5 illustrates an embodiment of a system in which the system is implemented by a lender in accordance with an embodiment of the present invention.

FIG. 6 illustrates an embodiment of a system in which a system verifies a tax return received from a lender in accordance with an embodiment of the present invention.

FIG. 7 illustrates an embodiment of a system in which an E-file provider verifies tax return information in accordance with an embodiment of the present invention.

FIG. 8 illustrates an embodiment of a system in which there is no checking with the IRS whether tax returns were amended in accordance with an embodiment of the present invention.

### DETAILED DESCRIPTION

A fast and convenient computer-implemented process for a trusted verification service to provide a verified copy of an income tax return is disclosed. Additionally, the process can be used to obtain a verified summary of income. The process is applicable to the large percentage of borrowers that directly or indirectly electronically file their tax records.

Many borrowers use a tax preparation software company to electronically file their tax returns. One aspect of the invention is the recognition by the inventors that a large percentage of prospective borrowers electronically file (“e-file”) their tax returns with e-file tax preparation providers such as Turbotax®. Additionally, many borrowers have their tax returns e-filed on their behalf by accounting firms effectively acting as e-file tax preparation providers, such as HR Block®.

There are different estimates of the percentage of Americans who e-file tax returns. However, some estimates place the percentage at about 70% in 2012 and there are predictions that this will rise to 80% or more in the future. (See IRS Oversight Board, “Electronic Filing 2012”, Annual Report To Congress, December 2012).

Another aspect of the invention is the recognition that the E-file providers maintain tax records for their customers. This information from the E-file providers is thus a potential source of information for the 70% or more of individuals who directly or indirectly e-file. Additionally, the E-file providers also maintain information on whether the tax returns were accepted by the government.

Yet another aspect of the invention is the recognition by the inventors that the information stored by E-file providers may be acquired and used to obtain verified tax information for prospective borrowers seeking a loan.

Still yet another aspect of the invention is the recognition by the inventors that online tools have been recently launched that permit comparatively quick checking whether a tax return has been amended “outside” of the e-file provider that filed the original returns. For example, the IRS has online tools for checking on the status of amended returns online. In April of 2013, the IRS launched the “Where's My Amended Return?” (WMAR) tool. The WMAR tool provides the status of Form 1040X Amended Tax Return for the current year and up to three prior years. The requirements for using the WMAR tool include providing a social security number, date of birth, and a zip code. This status check is extremely quick, i.e., a few seconds at most, assuming high speed connections and that the IRS tool is operating normally. If no amendments have been filed, a null answer is returned as the status report. Thus, online tools may be used by a tax verification service to rapidly check with the IRS whether or not a tax return has been amended. It will be understood that the WMAR tool is merely an illustrative example, and that more generally, any service authorized by a tax authority of the government may be used. For example, it is likely that other tools may be made available by the government in the future, including services operated through government contractors. Additionally, services available through state governments may also be used if it is desired to check state tax returns.

The trusted verification service implements the processes via software modules running on a computer system having at least one processor and a memory, as well as any necessary database systems, security mechanisms, servers, and interfaces. The software modules may, in turn, be stored or sold as computer instructions stored on a non-transitory compute readable medium.

Trust is an important part of the verification. The lender needs to trust that the information is valid and not tampered with. Additionally, borrowers need to have trust that their private information is secure. Depending on implementation, additional server support, including web servers, may be provided to access information over the Internet and maintain privacy and security of tax records. To support privacy and tamper-proofing, software and hardware to support privacy and security are also preferably included. Additional trust measures, such as generating certificates of authenticity, may also be employed.

No prior art manual processes exist that are comparable to the present invention. The present invention describe a new paradigm for the mortgage loan industry. Consequently, it will be understood that a computer system implementing any of the methods of the present invention functions as a specially programmed (special purpose) computer.

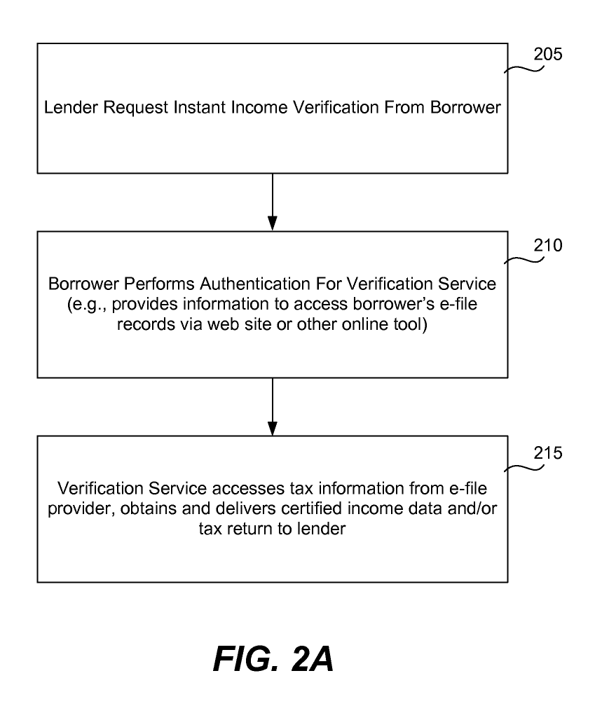

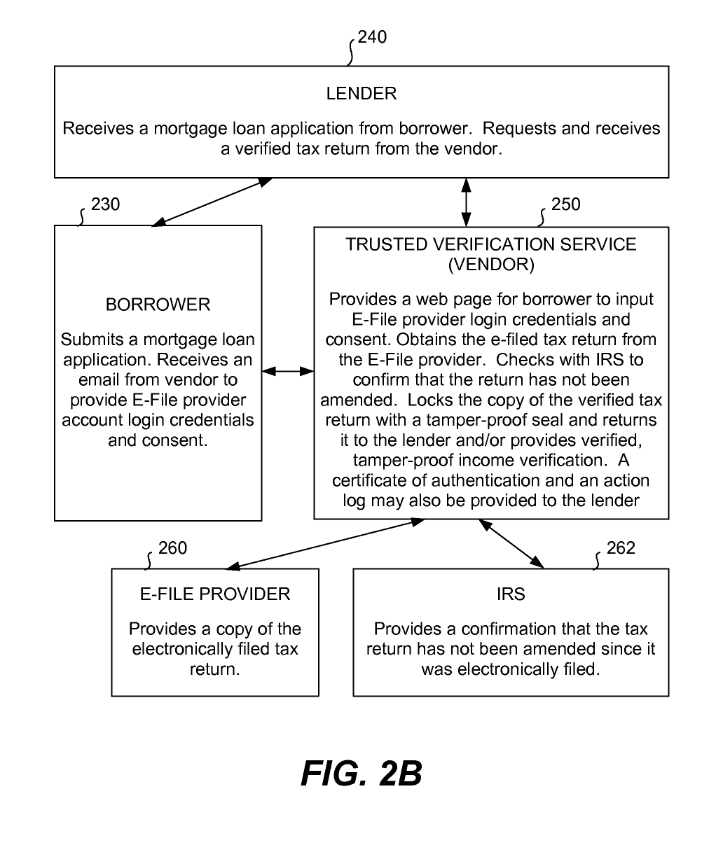

FIG. 2A illustrates a sequence of actions between a lender, a borrower, and a service provider in accordance with an embodiment of the present invention. A lender requests income verification from a borrower (step 205). The borrower then performs an authentication step for the trusted verification service (block 210). The authentication step includes the borrower providing sufficient information for the trusted verification service to access the borrower's tax records from an e-file provider. This includes any login credentials, the identity of the e-file provider, and any other information required to login and accesses the tax records of the borrower, which typically would include at least a user name and password. The borrower also provides any necessary consent required by law or by the terms of the e-file provider.

The authentication information may also include the full set of information required to check that no amendments have been filed with the IRS. For example, the IRS's WMAR tool requires a social security number, date of birth, and zip code. Alternately, some of the information (e.g., social security number) may be derived from the tax returns and/or the information may be provided by the lender.

The verification service then accesses tax information from the e-file provider, optionally checks for amendments. The verification service then generates and delivers verified income data and/or a verified tax return to a lender. The information may be provided to the lender with a certification of authenticity and be provided in a tamper proof document.

FIG. 2B illustrates a sequence of actions between a borrower, a lender, a tax verification vendor, an E-file provider, and the IRS, showing in more detail an exemplary sequence of actions. A borrower 230 submits a loan application to a lender 240. In this example, the lender requests the trusted verification service 250 to provide verified tax return information. In one embodiment the trusted verification service 250 operate as a third party vendor. For example, the third party vendor may operate as a web-based service provides services to the lending industry.

The trusted verification service 250, in turn, provides a web-page for the borrower 230 to input information sufficient to contact the E-file provider and access the borrower's tax records. The trusted verification service 250 then contacts the E-file provider 260 and receives, in return, a copy of the electronically filed tax return of the borrower. Related information (such as acknowledgement from the IRS accepting the tax return or any amended tax returns filed through the E-File provider) is provided to the tax verification vendor.

In one embodiment, the trusted verification service 250 also contacts the IRS 260 to receive a confirmation that the tax return has not been amended since it was electronically filed. For example, an online tool provided by the government, such as the WMAR online tool, may be used to acquire information on whether amended returns have been filed. (In an alternate embodiment, note that the E-File Provider could also request this information from the IRS on behalf of the borrower).

The trusted verification service then has several different options. First, it can provide a verified tax return in a tamper proof form to the lender. Secondly, if desired, summary information may be generated and provided to the lender.

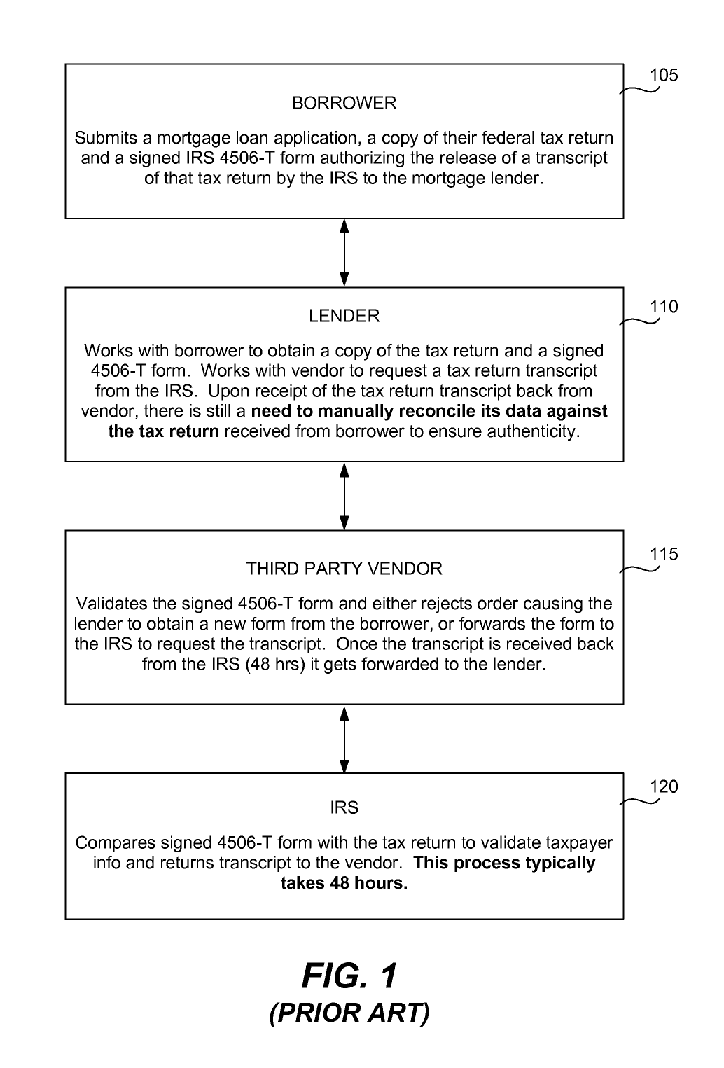

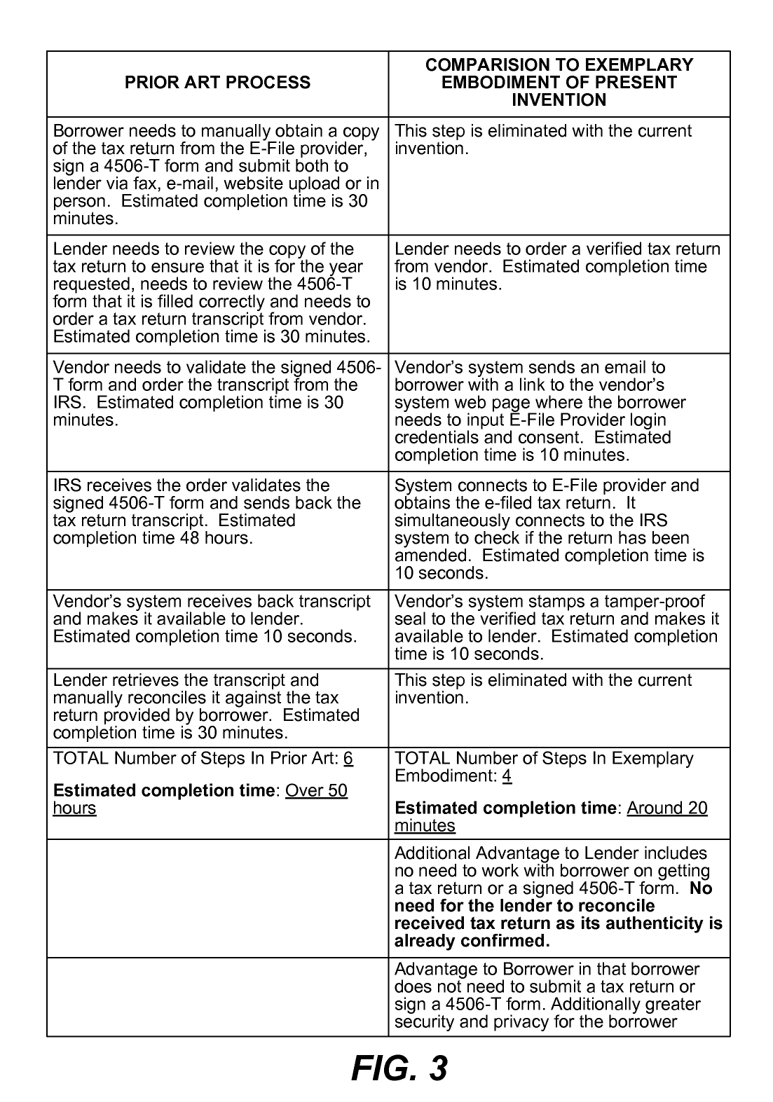

FIG. 3 illustrates a comparison of the method of FIG. 2B with the prior art method of FIG. 1. The estimated completion time for the prior art method is over 50 hours. In contrast, the estimated completion time for the method of FIG. 2B can be as little as 20 minutes or better, depending on factors such as Internet speed and access time at an E-file provider. Thus, the present invention provides a dramatic improvement and saves time and effort, making the loan application process easier and more efficient.

The advantage to both the borrower and the lender are substantial given the nature of the mortgage loan industry. Borrowers are often in a rush to search for a house, and saving several days of time to obtain a loan can provide a huge benefit. Additionally, both the borrower and the lender benefit from the improved efficiency of the system. Additionally, legitimate borrowers benefit from improved convenience and privacy protection.

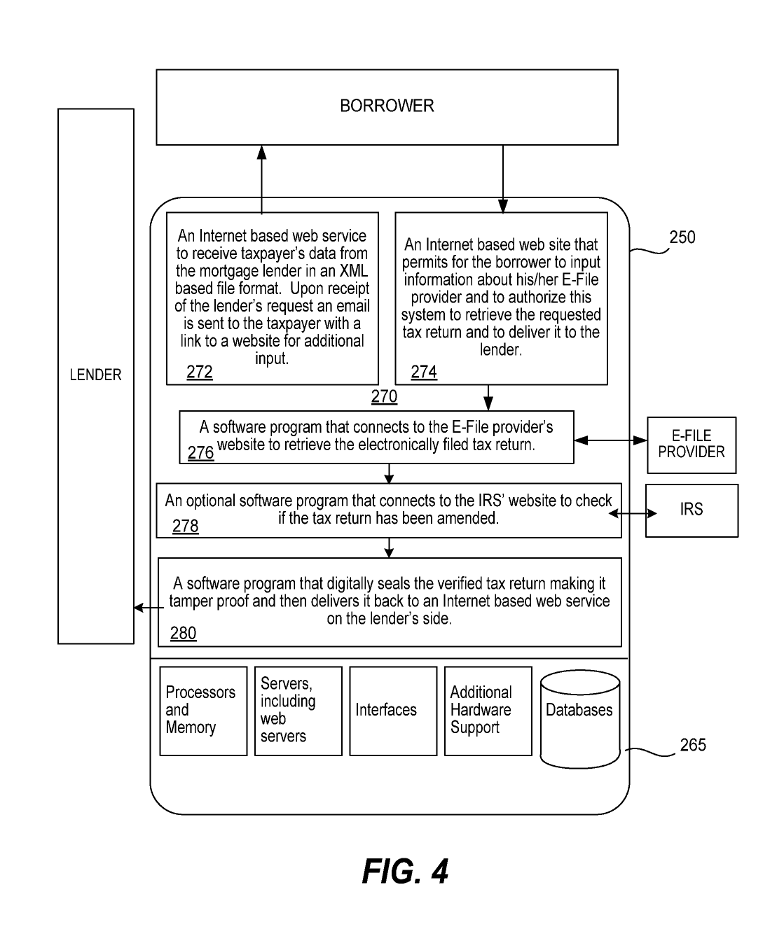

FIG. 4 illustrates an exemplary system to provide a trusted verification service 250 in accordance with an embodiment of the present invention. The system may be implemented as a computer system that includes both hardware and software components, such as a computer system, having one or more servers, computer processors, memory, and databases, with software modules stored on a computer readable medium. For the purposes of illustration, the trusted verification service 250 is conceptually divided into a hardware/support section 260 and a software system 270 for retrieving and delivery of a verified tax return. The hardware/support section 260 includes processors, memory, servers, interfaces, databases, and any additional hardware support.

The software system 270 of FIG. 4 includes an exemplary set of software modules and services for the purposes of illustration, although it will be understood that variations on what is illustrated are within the scope of the present invention. The software modules are stored on a non-transitory computer readable medium and execute on the hardware/support section 260.

In one embodiment a software module 272 receives information about the taxpayer sufficient to access the borrower's tax information from an E-file provider and information sufficient to access online tools to check on the status of any amendments with the IRS. This may include names, dates of birth, social security number, E-File provider information and user account login credentials. Additionally, it could include equivalent information, such as taxpayer ID information. Moreover, it may include whatever consent information or consent forms are required by E-File providers and any relevant state, local, and national privacy and consent laws to authorize the E-File provider to provide the borrower's tax information to a tax verification service. The software module 272 could be implemented in several forms depending on the needs of the software system user. An exemplary embodiment includes an Internet based web service that receives the data and any additional information and/or documents in an XML format (or other format that can be processed; an Internet based web page that provides a form for a user to input the necessary data and to upload any applicable documents; and any other software interface that allows the system to receive the data and any additional information and/or documents either as a manual user input or in a specific file format.

In one embodiment a software module 274 processes the data and send an email to the taxpayer with a link to a website where the taxpayer can provide his/hers E-File provider account login information and an authorization to allow the system to retrieve the electronically filed tax return from the E-File provider. This module 274, including email and a website, is only necessary if the login information and authorization requested from the taxpayer have not been provided by other means.

In one embodiment a software module 276 connects to the E-File provider to retrieve the tax return. This module 276 could be implemented in several forms depending on the available functionality of the E-File provider's software systems, including:
1) A request to an Internet based web service that is made available by the E-File provider. Such request can be in an XML file format or any other file format as requested by the E-File provider and it can include information about the taxpayer and the requested tax return as well as any additional information and/or documents requested by the E-File provider. The E-File provider can return the tax return in a PDF file format, or any other file format as determined by the E-File provider. The tax return file can be returned either in its raw form or it could be encapsulated in an XML file format, or any other file format as determined by the E-File provider. The tax return could be returned synchronously, meaning that the web service made available by the E-File provider will respond to the initial request made by the system as part of the same session, or asynchronously, meaning that the response by the web service will be part of a different session. An asynchronous response may be triggered by the E-File provider as a push to a web service listening on the end of the module described herein, or it could be in a response in a sub-sequent request to the E-File provider's web service that inquires about the status of the initial request.
2) A software program that will act as a web browser on behalf of the taxpayer. Such program will automate the tasks of connecting to the E-File provider website, login in to that website as the taxpayer, navigating through the website links and pages, and retrieving the tax return in the format made available by the E-File provider on the website.
3) Any other means provided by the E-File provider to connect and retrieve the tax return.
4) Note that many e-filing services also provide other services, such as the ability to file revised tax returns and receive confirmation of acceptance by the tax authority (e.g., IRS). Additionally, it will be understood that information on any amendments made to the tax return via the e-filing service could be improved, as well as any verifications received by the E-File Providers that the tax returns were acknowledged as being accepted by the tax authority.

However, the records maintained by the e-filing service may be incomplete should, for example, the borrower make subsequent voluntary amendments not implemented through the E-File Provider, or in the event of a government tax audit or tax lien. One option, to provide an additional level of fraud detection, is to include a software module 278 to connect to the appropriate tax authority system to check if the tax return has been amended since it was electronically filed. This module 278 could be implemented in several forms depending on the available functionality of the tax authority's software systems, including:
1) A request to an Internet based web service that is made available by the tax authority. Such request can be in an XML file format or any other file format as requested by the tax authority and it can include information about the taxpayer and the tax return, as well as any additional information and/or documents requested by the tax authority. The tax authority can return the result of the check in any file format as determined by the tax authority. The result of the check can be returned either in its raw form or it could be encapsulated in an XML file format or any other file format as determined by the tax authority. The result of the check could be returned synchronously, meaning that the web service made available by the tax authority will respond to the initial request made by the system as part of the same session, or asynchronously meaning that the response by the web service will be part of a different session. An asynchronous response may be triggered by the tax authority as a push to a web service listening on the end of the module described herein or it could be in a response in a subsequent request to the tax authority's web service that inquires about the status of the initial request.
2) A software program that will act as a web browser on behalf of the taxpayer. Such program will automate the tasks of connecting to the tax authority's website, login in to that website as the taxpayer, navigating through the website links and pages, and retrieving the result of the check in the format made available by the tax provider on the website.
3) Any other means provided by the E-File provider to connect and retrieve the tax return.

In one embodiment a software module 280 packages and delivers the verified tax return to the interested party. In one embodiment, additional security measures are employed to prevent tampering. In one embodiment, this module will place a digital tamper-proof stamp on the tax return and will make it available to the interested party by means specified by that party. For example, a tamper-proof stamp or security code could be placed on a PDF file of the verified tax return. The module 280 is optional and it could be implemented in a variety of ways as deemed necessary by the interesting party.

### USE EXAMPLES AND ALTERNATE EMBODIMENTS FOR THE INVENTION TO AUTHENTICATE TAX RETURNS, VALIDATE EXISTING RETURNS, AND AUTHENTICATE INCOME

It will be understood that the functionality of the invention may be implemented in different ways. In particular, it will be understood that different parties may implement features of the present invention. As examples, the functionality may be implemented by a third party vendor, by an E-file provider, and also integrated with a lender's service.

### Use Example 1

Referring to FIG. 4, in this example, a third party vendor provides the trusted verification service and delivers authenticated tax returns for lenders or other interested parties by getting a copy of these returns directly from E-File providers.

A mortgage lender is required to obtain a federal income tax return from a loan applicant and to validate the authenticity of that return for fraud prevention. To do so, they send an order to a third party vendor and provide basic information about the loan applicant, including names, social security number and email address. Upon receiving the order, the third party vendor sends an email to the loan applicant with a link to an Internet web page. On the web page, the loan applicant specifies what E-File provider was used to file the tax return and inputs the login credentials for his/hers online account with that E-File provider. The loan applicant also checks a box to authorize the third party vendor to obtain a copy of the tax return and to forward it to the mortgage lender. Upon receiving the information from the loan applicant, the third party vendor's system automatically connects to the E-File provider's website by using the loan applicant's login credentials and it retrieves a copy of the filed tax return. Simultaneously, the system connects to the IRS website and checks if the tax return has been amended. The system then seals the verified copy of the tax return, making it tamper-proof, and forwards it to the mortgage lender. Although processing times may vary depending on network conditions and other factors, the process can complete as fast as a few seconds once the loan applicant has provided login credentials and consent. There is no need for the loan applicant to manually pull the tax return and to forward it to the lender, and no need for the lender to reconcile the tax return as its authenticity is guaranteed by the method by which it was obtained.

### Additional Use Example 2

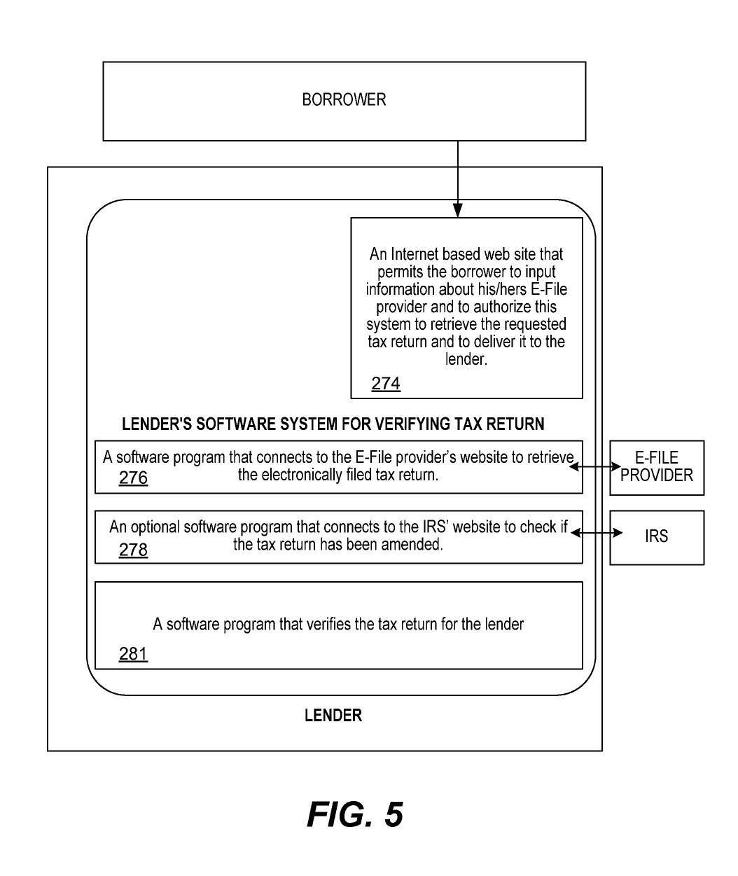

It will be understood that a large lender could also implement the verification service. As such, the lender would implement most of the modules of FIG. 4, with minor modifications, such as a software program 281 that verifies the tax return for the lender. Depending on implementation, some features, such creating a tamper-proof copy, may be less important due to the fact that the lender is implementing the service. FIG. 5 illustrates an example set of software modules that a lender could implement to provide the service for themselves (hardware omitted for clarity). Referring to FIG. 5, in this example, a lender or an interested party gets an authenticated tax return directly from an E-File provider. In this example, the E-file provider may implement features such as checking for amendments with the IRS. A mortgage lender can decide not to use a third party vendor to obtain a verified tax return as outlined in the typical use example above. In that scenario, the mortgage lender implements a system to obtain login credentials from the loan applicant and to connect to the E-File provider's and IRS' websites in order to obtain the tax return and check for amendments.

### Additional Use Example 3

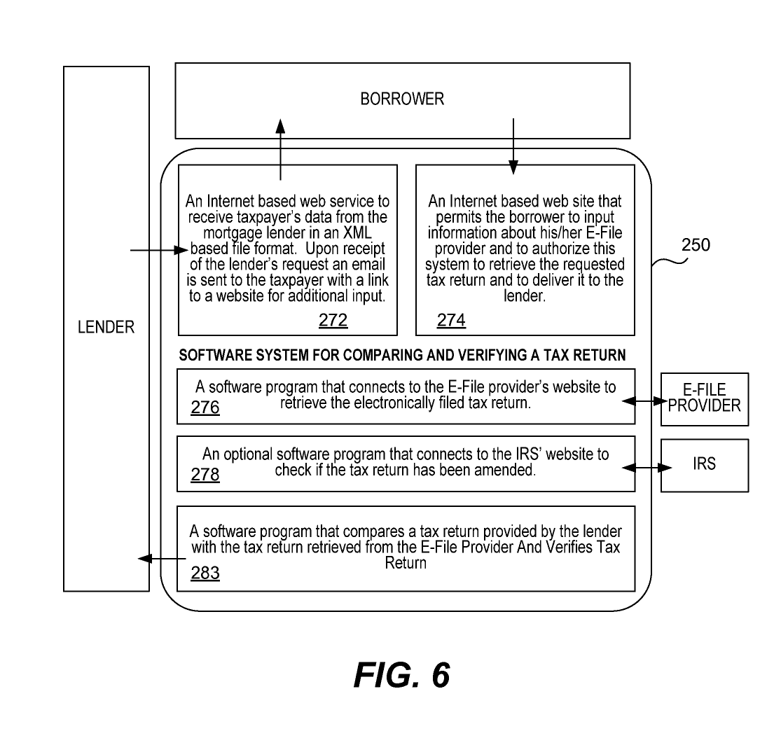

Referring to FIG. 6, in this example, a third party vendor offers a service to authenticate a tax return provided by a lender or an interested party by comparing it against a tax return retrieved from an E-File provider. In this example, the method is used to retrieve the tax return from the E-File provider, but the return is only used for comparison and it is not being delivered to the lender. Instead of delivering a verified federal income tax return, as outlined in the typical use example above, a third party vendor may offer a service to validate an existing copy of the tax return. In that scenario, the mortgage lender sends a copy of the tax return along with the rest of the information. The vendor implements a system to obtain the login credentials from the loan applicant and to connect to the E-File provider's and IRS' website to obtain the verified tax return. The vendor then reconciles the mortgage lender's copy of the tax return against the verified copy of the tax return and reports its findings to the mortgage lender. Module 283 supports comparing the tax return received from the lender with that obtained from the E-file provider.

### Additional Use Example 4

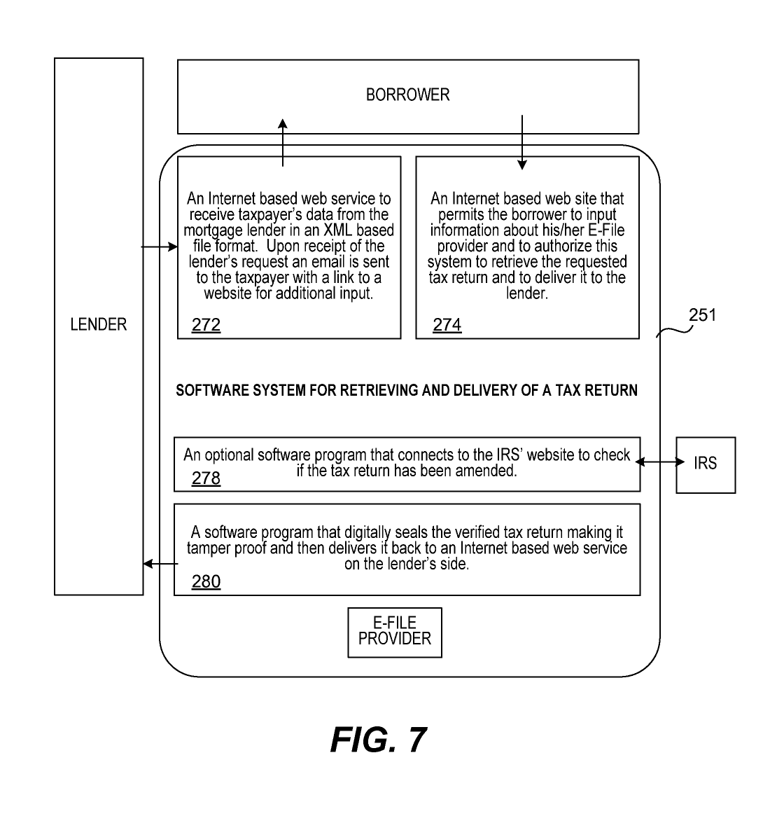

In one embodiment an E-File provider implements the trusted verification service. Referring to FIG. 7, in this example an E-File provider 251 offers a service to lenders and interested parties to provide them with authenticated tax returns (i.e. the e-file vendor executes steps such as checking for amendments. Checking for amendments with the IRS provides an additional level of verification. However, it will be understood that some lenders may not necessarily require this step. For example, some lenders may be satisfied in some circumstances without this additional step of verification. Consequently, in some embodiments, the method retrieves the electronically filed tax returns from the E-File provider without checking with the IRS that the return was subsequently amended.

### Additional Use Example 5

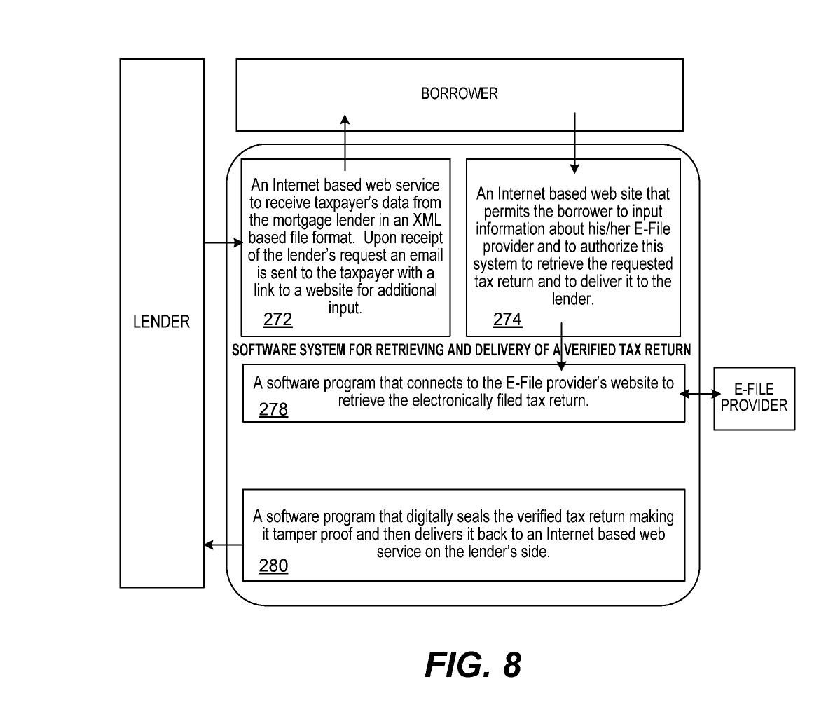

In FIGS. 4-7, there is an option to check with the IRS whether amendments have been filed. This is a useful option to provide an additional level of fraud protection, such that it is desirable to implement this option whenever possible. For example, government websites do occasionally crash and/or go through routine maintenance such that there may be occasions when this additional level of fraud protection might take longer than a few seconds such that it might warrant omitting this step. However, while it is desirable to include this additional level of fraud protection, it will be understood that this option may be entirely omitted in an alternate embodiment, as illustrated in FIG. 8.

### Alternate Embodiments to Re-Check Tax Return Information

In a typical use scenario the tax return information is verified once. However, it will be understood that once the verification service has performed an initial verification that the process may be repeated, if desired, during the loan process. For example, in many home buying scenarios a borrower is initially qualified and the lender provides a guarantee for a range of loan amounts. The borrower then goes about searching for a home and on closing negotiations on the home, after which the house goes through escrow and closing. The entire process might take many weeks and thus extend over a tax payment date. Additionally, in some rare situations the borrower may amend their tax returns during the home-hunting process. Thus, if desired, the user's consent to re-verify the tax information may be requested and the verification service would then perform a second tax verification step.

### Additional Alternate Embodiments of the Invention to Generate a Verified Summary of a Subset of Tax Information

It will also be understood that individual fields of a tax return may also be verified to generate a verified summary, such as those particular fields relevant to a lender or to others interested in the financial resources of an applicant.

Additionally, the income information may be processed and provided to the lender in the form of income checks and alerts.

For example, a mortgage lender may desire to receive a verified summary of the most relevant information related to the ability to payback a loan. The summary could be in addition to the complete verified tax return or as an alternative.

Alternatively, it will be understood that the summary may be provided in areas outside of traditional home mortgage lending, such as a summary for obtaining other types of loans or as evidence of credit worthiness in other contexts, such as rentals.

### Additional Security and Privacy Implementation Examples

It will be understood that state-of-the art web security technology is preferably used. An exemplary system, implemented in 2013, includes services hosted at a Statement of Auditing Standards (SAS) 70 type II Certified facility. Web communications and data transmissions may be implemented with as Secure Socket Layer (SSL) based communications utilizing 128 bit encryption or better. More generally, the data security and privacy implementation may be implemented in accordance with the recommendations and requirements of government agencies and any relevant industry associations.

In one embodiment, a certificate of authenticity and an action log is provided to the lender. The certificate of authenticity provides an additional measure of trust to a lender. The certificate of authenticity, if used, is implemented to demonstrate that the income information is coming from the trusted verification service. The certificate may be implemented, for example, using the approaches taken in ecommerce and finance areas to verify links, websites, and sources of products. As examples, the certificate may take the form of a digital certificate or digital signature; alternatively it may take the form of a digital watermark or a visual code.

From the perspective of the lender, proving the income information in a tamper-proof form is a measure that aids in preventing fraud. While examples of tamper-proofing have been described, it will be understood that the income information may be provided using other tamper-proofing techniques that may be developed in the future.

As previously discussed, the verification services requires connecting with the tax preparation software company of the borrower (the E-file Provider). This, in turn, requires the service to access the borrower's online account with that company. In one embodiment the verification services requests the user name, password and any other login information that the borrower has setup up with that company to enable access.

Borrowers may have privacy concerns about providing their login credentials, given the large amounts of private information associated with their tax returns. Thus, it is desirable to provide privacy protections measures for the borrower while also facilitating ease of use for the borrower.

The login credentials are used to download tax returns and other information used in providing the verification services. Additionally, the login credential may be required for additional time periods to address errors or service interruptions in the download process. Storing the borrower's login credentials may be performed on a temporary basis to deal with issues such as service interruptions and error issues. However, it may also be useful to store the login credentials to make it easier for the borrower to reapply for a loan at a later time, or for other reasons.

A privacy protection protocol is preferably implemented. A retention policy defining how long and under what privacy protection conditions the login credentials are stored may be implemented. The borrower is preferably informed about the privacy protection policy.

If the verification service stores the borrower's login credentials, it preferably maintains and encrypts them on firewall-protected servers. This login information is encrypted and transmitted using secure socket layer technology, making it unreadable during transmission. It is then stored on secure servers.

Additional techniques may be employed to authenticate to the borrower that the user interfaces are secure. That is, the borrower may be provided with an indication or indicators to verify that the user interface is not a spamming attempt by a malicious party. In the case of the link/user interface being triggered in response to a request from a lender, information about the lender, a loan application ID, or other information may be provided. Any technique utilized in ecommerce and online finance to indicate that a site or a link is a trusted site/link may also be utilized to aid a borrower in understanding that the link/user interface is genuine and not a spamming attempt. Consequently, it will be understood that the process flows may be varied from those describe above to include additional security and/or assurance to the borrower that the user interface is genuine and that the borrower's confidential information will be given a high level of privacy protection.

While the convenience of the borrower is an important consideration, there may be a subset of borrowers that prefer to directly login to the trusted verification service rather than use a link sent to them. Additionally, a borrower could pre-register with a trusted verification service prior to applying for a loan. It will thus be understood that such variations are within the scope of embodiments of the present invention.

### Additional Embodiments

While the invention has been described in conjunction with specific embodiments, it will be understood that it is not intended to limit the invention to the described embodiments. On the contrary, it is intended to cover alternatives, modifications, and equivalents as may be included within the spirit and scope of the invention as defined by the appended claims. The present invention may be practiced without some or all of these specific details. In addition, well known features may not have been described in detail to avoid unnecessarily obscuring the invention.

As previously discussed, the software modules to implement the above-described processes may be implemented on a variety of different computer systems. In accordance with the present invention, the components, process steps, and/or data structures may be implemented using various types of operating systems, programming languages, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. The methods of the present invention may also be tangibly embodied as a set of computer instructions stored on a computer readable medium, such as a memory device.

1. A computer implemented method for a lender to obtain tax return information for making a mortgage lending decision without requiring the borrower to provide tax returns and authorization to obtain tax transcripts from the Internal Revenue Service, comprising:
receiving, by a computer system, a request from a lender to obtain income information for a borrower;
providing, by the computer system, a secure user interface for the borrower to enter information;
receiving, at the computer system, authentication information from the borrower, including information about the E-File tax preparation provider that was used to prepare and file the tax return for the borrower and access information, in the form of one or more of: login credentials used by the taxpayer to access their account with the E-File provider, consent to allow the E-File tax preparation provider to release the tax return to the interested party, and an interface or access protocol of the E-File tax preparation provider to release the tax return to the interested party;
securely storing, by the computer system, the received authentication information in an encrypted format on a secure server according to a privacy protection protocol in order to protect the privacy of confidential information of the borrower;
obtaining, by the computer system, a copy of the electronically filed tax return from the E-File tax preparation provider using the access information;
checking with an online Internal Revenue Service, by the computer system, whether the tax information of the borrower was amended after filing; and
generating, by the computer system, verified tax information for the borrower including:
securely transmitting to the lender, by the computer system, tamper-proof verified income information of the borrower, including at least one of verified income data and a verified tax return; and
providing a certificate of authenticity to the lender.

2.-16. (canceled)

17. A system for providing verified tax information to a lender without requiring a borrower to provide tax returns and authorization to obtain tax transcripts from the Internal Revenue Service, comprising:
a server computer including at least one processor, a memory, and having secure interfaces and firewall protection for communicating with a borrower, a lender, and an E-file tax preparation provider;
the system including computer program code residing on the memory to:
receive via a secure web interface, at a server computer, authentication information from the borrower and, encrypt and securely store the authentication information in a firewall protected server, the authentication information including information to obtain tax return information from the borrower's e-file tax preparation provider;
obtain, by the server computer, the tax return information from the borrower's E-file tax preparation provider via a secure web interface;
generate, at the server computer, verified income information from the tax return information of the borrower;
digitally sealing the verified income information to make it tamper-proof and provide, by the server computer, the tamper-proof verified income information to a lender via a secure web interface for at least an initial loan approval process.

18. The system of claim 17, wherein the verified income information includes at least one of a verified copy of the borrower's tax return and a summary of the borrower's income.

19. (canceled)

20. The system of claim 17, wherein the server computer provide a certificate of authenticity to the lender.

21. The system of claim 17, wherein the authentication information from the borrower is securely stored according to a privacy protection protocol in order to preserve privacy of the authentication information.

22. The system of claim 17, wherein the server computer receives a request from the lender for verified income information and in response providing a user interface for the borrower to input the authentication information.

23. The system of claim 17, wherein the authentication information includes the borrower's name, social security number, and the E-file tax preparation provider used to prepare the tax return for the borrower.

24. The system of claim 17, wherein the authentication information includes login credentials used by the taxpayer to access their account with the E-File tax preparation provider.

25. The system of claim 17, wherein the authentication information includes the consent of the borrower.

26. A system for providing verified tax information to a lender without requiring a borrower to provide tax returns and authorization to obtain tax transcripts from the Internal Revenue Service, comprising:
a server computer including at least one processor, a memory, and having secure interfaces and firewall protection for communicating with a borrower, a lender, and an E-file tax preparation provider;
the system including computer program code residing on the memory to:
receive via a secure web interface, at a server computer, authentication information from the borrower and, encrypt and securely store the authentication information in a firewall protected server, the authentication information including information to obtain tax return information from the borrower's e-file tax preparation provider, wherein the authentication information from the borrower is securely stored according to a privacy protection protocol in order to preserve privacy of the authentication information;
obtain, by the server computer, the tax return information from the borrower's E-file tax preparation provider via a secure web interface;
generate, at the server computer, verified income information from the tax return information of the borrower;
perform, by the server computer, an online status check with at least the Internal Revenue Service to check that the tax return of the borrower has not been amended;
digitally sealing the verified income information to make it tamper-proof and
provide, by the server computer, the tamper-proof verified income information to a lender via a secure web interface for at least an initial loan approval process; and
wherein the server computer provides a certificate of authenticity to the lender.

27. The system of claim 26, wherein the status check includes checking with the E-File tax preparation provider whether the E-File tax preparation provider filed amended returns on behalf of the borrower.

28. (canceled)

29. The system of claim 26, wherein the status check is performed by querying the Where's My Amended Return (WMAR) online service of the Internal Revenue Service to check that the tax return has not been amended.

30. The system of claim 26, wherein the system is configured to re-verify income information prior to the closing of a loan.

31. A computer implemented method for a lender to obtain tax return information for making a mortgage lending decision without requiring the borrower to provide tax returns and authorization to obtain tax transcripts from the Internal Revenue Service, comprising:
receiving, by a computer system, a request from a lender to obtain income information for a borrower;
providing, by the computer system, a secure user interface for the borrower to enter information;
receiving, at the computer system, authentication information from the borrower, including information about the E-File tax preparation provider that was used to prepare and file the tax return for the borrower and access information, in the form of one or more of: login credentials used by the taxpayer to access their account with the E-File provider, consent to allow the E-File tax preparation provider to release the tax return to the interested party, and an interface or access protocol of the E-File tax preparation provider to release the tax return to the interested party;
securely storing, by the computer system, the received authentication information in an encrypted format on a secure server according to a privacy protection protocol in order to protect the privacy of confidential information of the borrower;
performing an initial verification of income and at least one subsequent verification during the life of a loan process, each verification including:
1) obtaining, by the computer system, a copy of the electronically filed tax return from the E-File tax preparation provider using the access information;
2) checking with an online Internal Revenue Service, by the computer system, whether the tax information of the borrower was amended after filing; and
3) generating, by the computer system, verified tax information for the borrower including:
4) securely transmitting to the lender, by the computer system, tamper-proof verified income information of the borrower, including at least one of verified income data and a verified tax return; and
5) providing a certificate of authenticity to the lender.
